(19) United States
(12) Patent Application Publication
(10) Pub. No.: US 2003/0184525 A1
(43) Pub. Date: Oct. 2, 2003

(54) Method and apparatus for image processing

(75) Inventor: Alex Tsai, Taipei (TW)

Correspondence Address: Richard P. Berg, Esq., c/c LADAS & PARRY, Suite 2100, 5670 Wilshire Boulevard, Los Angeles, CA, 90036-5679, US

(73) Assignee: MITAC INTERNATIONAL CORP.

(21) Appl. No.: 10/233,100

(22) Filed: Aug. 28, 2002

(30) Foreign Application Priority Data
Mar. 29, 2002 (TW) 91106413

(51) Int. Cl. G09G 5/00

(52) U.S. Cl. 345/173

(57) ABSTRACT

A method for image processing. The method comprises the steps of providing a touch panel, displaying an image on the touch panel, obtaining a dragging path generated by a user touching and dragging from a first to a second point on a surface of the touch panel, determining a rotation angle according to a relative position between the first and second points on the surface of the touch panel, and displaying the image rotated with the rotation angle on the touch panel.

### BACKGROUND OF THE INVENTION

1. Field of the Invention

The present invention relates to a method and apparatus for image processing, and particularly to an image processing method and apparatus for touch panels.

2. Description of the Prior Art

Software applications with Graphical User Interface (GUI) have been popularly used, as they are very friendly to users. GUI is now a necessary element in any software application. Therefore, pointing devices, such as mouse pointers, are elementary input devices for computers. However, the users must move the pointer on a display by moving the mouse on a desk. This is not convenient for notebook or personal digital assistant users, or users of other portable electronic devices, such as mobile phones.

Touch panels provide a solution for the problem. The users need not move the mouse on a desk but only their fingers to touch and drag on the panel to move the pointer. This is a very good GUI input device for portable system users.

FIGS. 1A˜1C are diagrams showing a conventional image processing method for a PDA with a touch panel.

As shown in FIG. 1A, the PDA 1 has a touch panel 11 and keypads 12 for users to move a curser or select items. A snowman image 13 and rotation button 14 are displayed on the touch panel. The users touch the button 14 on the panel 11 first when they want to rotate the image 13.

As shown in FIG. 1B, a menu 15 pops up when the users touch the button 14 on the panel 11. The menu 15 has three buttons 151˜153 for a clockwise 90 degree rotation, a counterclockwise 90 degree rotation and an upside down rotation respectively.

As shown in FIG. 1C, for example, when the users touch the button 151 on the panel 11, an upside down snowman image 13 is displayed on the panel 11.

However, it is not convenient for the users to complete the image rotation by touching the buttons one by one.

### SUMMARY OF THE INVENTION

The object of the present invention is to provide a method and apparatus for image processing wherein the users complete the image rotation by simply dragging on the panel.

The present invention provides a method for image processing. The method comprises the steps of providing a touch panel, displaying an image on the touch panel, obtaining a dragging path generated by a user touching and dragging from a first to a second point on a surface of the touch panel, determining a rotation angle according to a relative position between the first and second points on the surface of the touch panel, and displaying the image rotated with the rotation angle on the touch panel.

The present invention further provides an apparatus for image processing. The apparatus comprises a touch panel, and a central processing unit displaying an image on the touch panel, obtaining a dragging path generated by a user touching and dragging from a first to a second point on a surface of the touch panel, determining a rotation angle according to a relative position between the first and second points on the surface of the touch panel, and displaying the image rotated with the rotation angle on the touch panel.

Thus, a dragging path generated by the user is used to determine the rotation angle of the image. The user only needs to drag on the panel to complete the rotation.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIGS. 1A˜1C are diagrams showing a conventional image processing method for a PDA with a touch panel.

FIGS. 2A˜2C are diagrams showing an image processing method for a PDA with a touch panel according to one embodiment of the invention.

FIG. 3 is a flowchart of a method for image processing according to one embodiment of the invention.

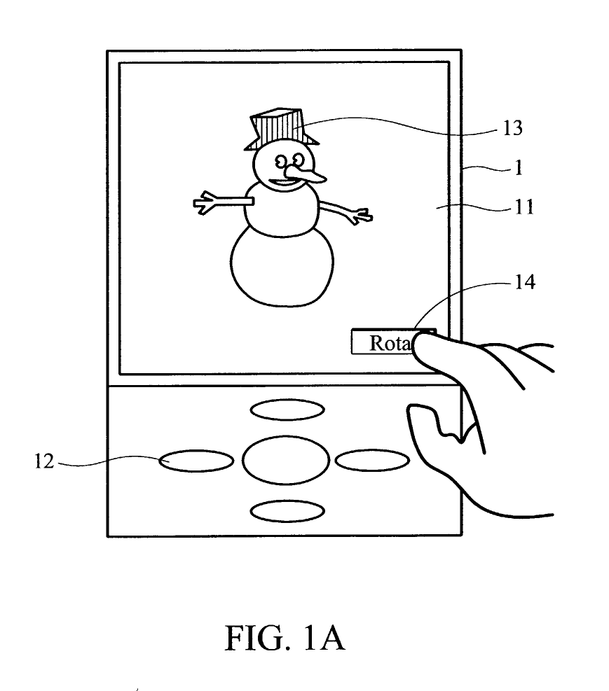

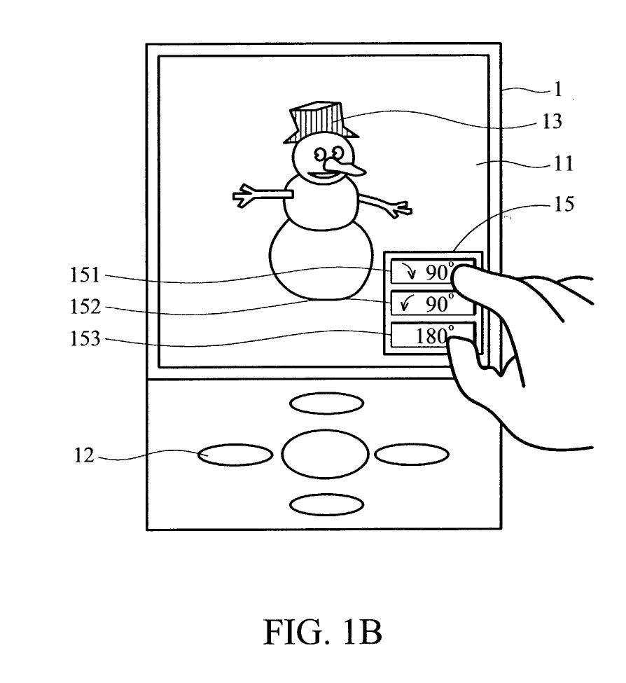

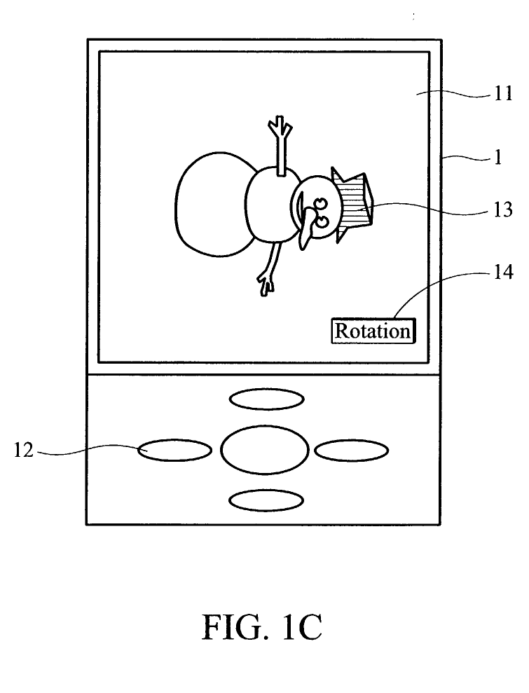

### DETAILED DESCRIPTION OF THE INVENTION

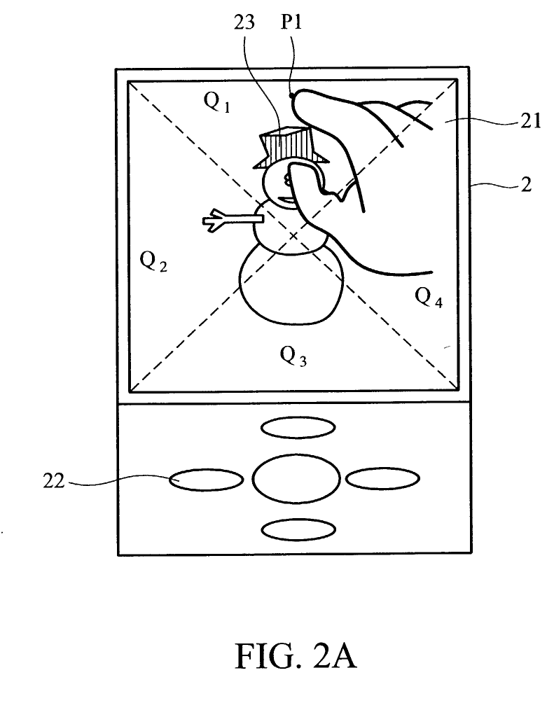

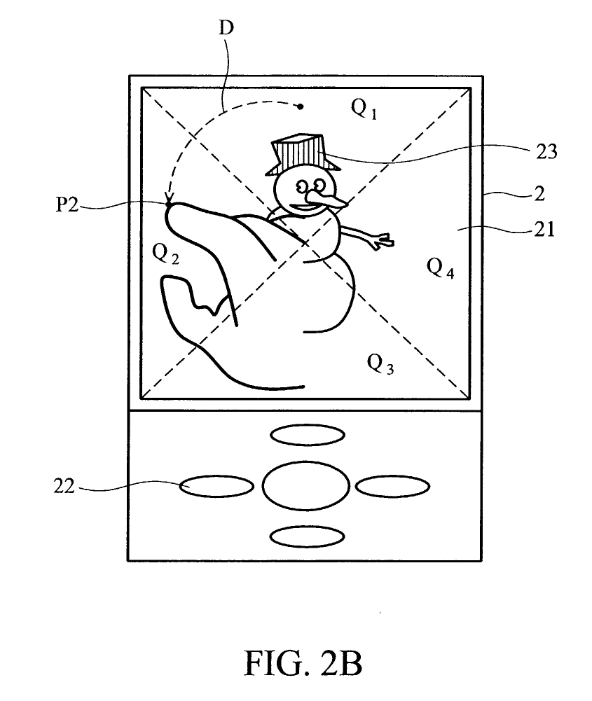

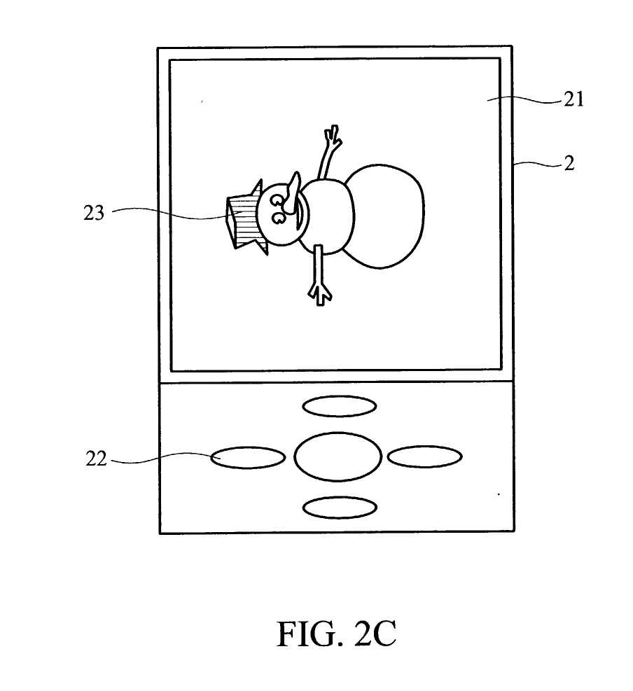

FIGS. 2A˜2C are diagrams showing an image processing method for a PDA with a touch panel according to one embodiment of the invention.

As shown in FIG. 2A, the PDA 2 has a touch panel 21 and keypads 22 for users to move a curser or select items. A snowman image 23 is displayed on the touch panel 21 by the central processing unit (CPU) 201 of the PDA 2. The surface of the panel 21 is geometrically divided into quadrants Q1˜Q4. The user touches a point P1 in the quadrant Q1 on the panel 21.

As shown in FIG. 2B, the user drags on the panel 21 from the point P1 in the quadrant Q1 to a point P2 in the quadrant Q2. A dragging path D with a starting point P1 and ending point P2 is therefore generated.

As shown in FIG. 2C, the CPU 201 obtains the dragging path D from the touch panel 21. A rotation angle is determined by a relative position of the points P1 and P2. The quadrants Q1˜Q4 have directions of 0, 90, 180 and 270 degrees. The points P1 and P2 are located in the quadrants Q1 and Q2, and the rotation angle is an angular difference between the directions of the quadrants Q1 and Q2, which is 90 degrees. The rotation is counterclockwise since the dragging path is from the point P1 to P2.

In the previously described embodiment, the surface of the panel 21 can be divided into more sectors than quadrants for more rotation angles. For example, the rotation angles can be 0, 60, 120, 180, 240, or 300 degrees when there are six sectors.

Further, the user can rotate the image with any angle when the rotation angle is determined as the angle formed by a center point of the panel surface, the point P1 and P2.

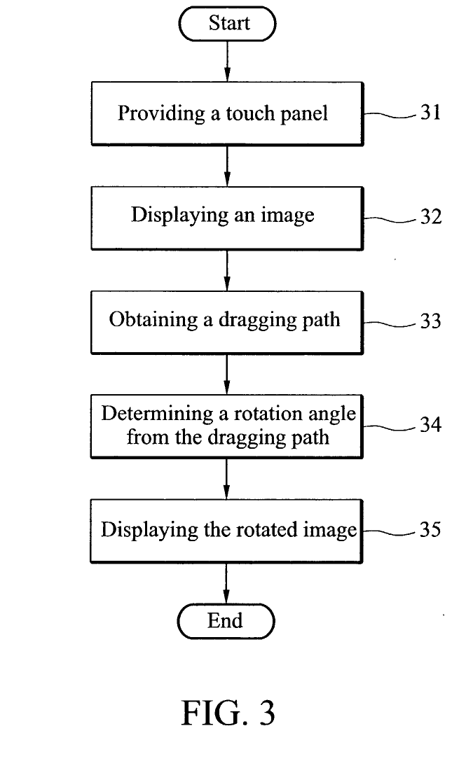

FIG. 3 is a flowchart of a method for image processing according to one embodiment of the invention.

In step 31, a touch panel is provided. Users can use their fingers to touch and drag on the panel to move the pointer.

In step 32, an image is displayed on the touch panel.

In step 33, a dragging path generated by a user touching and dragging from a starting point to an ending point on a surface of the touch panel is obtained.

In step 34, a rotation angle is determined according to a relative position between the starting and ending points on the surface of the touch panel. The surface of the touch panel is geometrically divided into quadrants or sectors with directions, the starting and ending points are located in two of the sectors, and the rotation angle is an angular difference between the directions of the two sectors.

In step 35, the image rotated with the rotation angle is displayed on the touch panel.

In conclusion, the present invention provides a method and apparatus for image processing wherein the users complete the image rotation by simply dragging on the panel. a dragging path generated by the user is used to determine the rotation angle of the image. The user only needs to drag on the panel to complete the rotation.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for image processing comprising the steps of:
providing a touch panel;
displaying an image on the touch panel;
obtaining a dragging path generated by a user touching and dragging from a first to a second point on a surface of the touch panel;
determining a rotation angle according to a relative position between the first and second points on the surface of the touch panel; and
displaying the image rotated with the rotation angle on the touch panel.

2. The method as claimed in claim 1, wherein the surface of the touch panel is geometrically divided into a plurality of sectors with directions, the first and second points are located in first and second sectors respectively, and the rotation angle is an angular difference between the directions of the first and second sectors.

3. The method as claimed in claim 2, wherein the sectors are quadrants.

4. The method as claimed in claim 1, wherein the first and second points are starting and ending points of the dragging path.

5. An apparatus for image processing comprising:
a touch panel; and
a central processing unit displaying an image on the touch panel, obtaining a dragging path generated by a user touching and dragging from a first to a second point on a surface of the touch panel, determining a rotation angle according to a relative position between the first and second points on the surface of the touch panel, and displaying the image rotated with the rotation angle on the touch panel.

6. The apparatus as claimed in claim 5, wherein the surface of the touch panel is geometrically divided into a plurality of sectors with directions, the first and second points are located in first and second sectors respectively, and the rotation angle is an angular difference between the directions of the first and second sectors.

7. The apparatus as claimed in claim 6, wherein the sectors are quadrants.

8. The apparatus as claimed in claim 5, wherein the first and second points are starting and ending points of the dragging path.
